(19) United States
(12) Patent Application Publication
(10) Pub. No.: US 2011/0239465 A1
(43) Pub. Date: Oct. 6, 2011

(54) HAIR REMOVAL DEVICE HAVING A DEVICE FOR PREPARING THE SKIN

(76) Inventor: Gerhard Goetz, Rosstal (DE)

(21) Appl. No.: 13/070,628

(22) Filed: Mar. 24, 2011

Related U.S. Application Data
(63) Continuation of application No. PCT/IB2009/054190, filed on Sep. 24, 2009.

(30) Foreign Application Priority Data
Sep. 24, 2008 (DE) 102008048725.2

(51) Int. Cl. B26B 19/42

(52) U.S. Cl. 30/34.2

(57) ABSTRACT

A hair removal device having a device for preparing the skin is disclosed. The hair removal device has a shaving or cutting device for removing hairs, the shaving or cutting device having a front line of action along which hairs are removed by the shaving or cutting device. In front of the shaving or cutting device, there is situated a spacer for producing a defined skin wave between the front line of action and the spacer, the spacer being situated at a distance from the front line of action.

### CROSS REFERENCE TO RELATED APPLICATION

This application is a continuation of prior co-pending International Application No. IB2009/054190, filed Sep. 24, 2009, designating the United State.

### FIELD OF THE INVENTION

The present invention relates to a hair removal device having a shaving or cutting device for removing hairs. The shaving or cutting device has a device for preparing the skin in order to improve the shaving result.

### BACKGROUND OF THE INVENTION

Hair removal devices of the type named above are known in the prior art. There are a large number of different hair removal devices that are designed according to different principles of operation.

The most widely distributed are electric shavers that operate with upper and lower blades, the upper blade regularly being fashioned as a shaving foil and the lower blade being fashioned as shaving heads that oscillate relative to the shaving foil. Through openings in the shaving foil, beard stubble passes into a space under the shaving foil and is there engaged and shaved off by the lower blades. In addition, there are rotary shaving systems that operate according to the same principle, but use rotating lower blades.

Very often, long-hair cutters, or so-called pre-cutters, are used, with which too-long beard hairs are to be shortened before the use of the above-described cutting systems, in order to improve shaving time and the shaving result. These devices are also called beard pre-cutters, beard trimmers, or the like. Whole-body hair removal devices, or feminine shavers, generally also operate according to the same principle.

In devices of the type named above, it is known that the shaving result can be improved by mechanically preparing the skin that is to be shaved, in order, for example, to lift up beard hairs. From US 2001/0027608 A1, a shaving apparatus is known that has an edge for supporting the skin positioned in front of a cutting unit. The edge has a broad contact surface terminating in a relatively sharp edge.

The device disclosed in WO 2007/105138 A2 operates according to the same principle.

A disadvantage of these systems is that when the razor is advanced over the skin, a wave of skin is formed in front of the edge, causing tension in the skin as the razor advances, which, on one hand, can cause skin irritations and, on the other, causes a bulging of the skin oriented towards the tips of the hair while the roots of the hair are fixed in the underlying layer of skin, so that the hair is practically pulled back into the skin, which works against the cutting close to the hair root that is desirable for a thorough shave. This effect becomes greater the more firmly the razor is pressed against the skin and the softer the skin is, for example on the throat or other areas of the body. In addition, it has been shown that, due to the mechanical stress on the skin, more skin irritations occur given a larger wave of skin pushed in front of the razor.

From GB 519,367, a razor is known that has a front-positioned slotted or comb-type protective device that is intended to bring about the lifting of hairs, and which, in addition, is intended to produce a distribution of skin tension oriented transversely to the movement of direction of the razor. In the movement of direction of the razor, the skin protection device is situated in such a way that the skin is tensioned in the shape of an arc via the skin protection device and a shaving foil. A lifting of the hairs that are to be cut is achieved via elements that produce a distribution of skin tension transverse to the direction of movement.

A disadvantage of the above-named system is that a uniform shaving quality is not produced over the width of the razor, because the skin is correspondingly tensioned only in certain zones, whereas in other zones the skin is compressed.

Finally, from DE 25 13 748, a dry shaver is known having a curved rectangular shaving blade and a device for tensioning the skin, the device having at least one wire that is positioned in front of the curved shaving blade, approximately parallel to the curved-around edges of the shaving blade, approximately in the center of the shaving blade, and is stretched taut in the manner of a string in the shaving head housing. The wire can lie directly on the shaving blade or can be situated at a distance therefrom.

A disadvantage of the corresponding device is that the use of the shaver is made significantly more difficult, because the shaver cannot be applied in its most natural position, namely almost perpendicular in the center of the shaving blade. Moreover, the shaver functions only when moved in the direction of being pushed forward, and not in the direction of being drawn, which is a more natural shaving movement.

The devices known from the prior art all have the further disadvantage that given larger skin waves, lower skin layers, including the hair roots, are significantly less pushed together than an upper skin layer. When pushed together, the upper skin layer forms small folds or waves in the skin, so that, on one hand, the hairs that are to be cut can sink into the “troughs” of these waves, or the waves can cover the hairs that are to be shaved so that the hairs are not threaded and engaged by the razor. On the other hand, at the “peaks” of these waves, the skin rolls over the hair duct, so that the hairs sink further into the skin and cannot be cut off at the optimal possible length. After the razor is removed, the skin wave no longer exists, and the hairs reappear. This yields a poor shaving result.

In addition, the devices known from the prior art have the disadvantage that they tend to be comparatively prominent, which increases the difficulty of handling the razor and its use on strongly curved parts of the body, for example on the chin or under the nose.

### SUMMARY OF THE INVENTION

Against this backdrop, the present invention is based on the object of developing a hair removal device of the type named above in such a way that a better shaving result can be achieved while simultaneously protecting the skin from skin irritations. The corresponding device should, in addition, be capable of being used effectively even in strongly curved areas.

This object is achieved by a hair removal device according to the present invention. Additional advantageous embodiments are also disclosed.

A hair removal device according to the present invention has a shaving or cutting device. The shaving or cutting device can be fashioned according to the designs disclosed in the prior art.

The shaving and cutting device can be guided in, among others, sawing or chopping movements, or can also rotate. In the case of sawing movements, a shaving system or a blade is moved essentially perpendicularly to a direction of advance of the shaving and cutting device, while, in the case of chopping movements, it is moved essentially in the direction of advance of the shaving and cutting device.

The shaving or cutting device has a front line of action along which hairs are removed by the shaving or cutting device. In the case of shaving or cutting devices having a comb, the line of action is determined by a front edge of the comb.

In many devices, hairs are removed not only along a line of action, but also on a contact surface, such as, for example, in razors having an upper and lower blade, in which the upper blade is fashioned as a shaving foil. However, these devices also have a front boundary line along which hairs are removed at the earliest point. In the following, the earliest line of contact is referred to as the front line of action.

Thus, the present invention is also capable of being used with hair removal devices that remove hair along surfaces.

In the case of rotating lower blades, the front line of action is determined by a radially outer end of the shaving parts. In the case of shaving foil razors that operate using oscillating lower blades, a front line of action is determined by a zenith line of the shaving foil.

In the case of razors having two shaving heads, the front lines of action of the shaving heads are determined by a zenith line of the respective shaving foils.

In long-hair cutters, beard trimmers, or the like that operate according to the scissors principle, the front line of action is determined by a front edge of the shaving comb.

The shaving or cutting device has a spacer positioned in front of it in order to produce a defined skin wave between the front line of action and the spacer. The spacer is situated at a distance from the front line of action. The spacer according to the present invention makes possible a defined formation of a skin wave between the spacer and the shaving foil.

The defined skin wave first causes a slight bulging of the skin in the area between the spacer and the front line of action. The bulge is small enough that no folds occur there between which hairs could be hidden or that curve at the hair duct toward the tip of the hair while the hair is held by its root in a lower skin layer. Due to the required pressure of the razor on the skin during shaving, the soft upper skin is additionally compressed relative to lower skin layers, so that the hairs stand out further, because the hair roots are standardly situated 3 mm to 4 mm below the uppermost skin layer. Therefore, the hairs can be engaged and cut at a particularly deep point by the shaving or cutting device, yielding a particularly good shaving result. The defined skin wave thus also compensates for the effect of a larger skin wave created in front of the spacer.

A further effect is that through the formation of a defined skin wave between the front line of action and the spacer, the formation of greater skin tension, and skin irritations caused thereby, can be prevented. During use of the hair removal device, the skin surrounds the spacer and glides along with it. When the hair removal device is advanced on the skin, the skin is only slightly pre-tensioned, such that a limitation of the skin tension is possible through the formation of the defined skin wave.

In addition, through the production of a defined skin wave between the front line of action and the spacer, a high tolerance can be achieved with regard to different levels of pressure of the hair removal device against the skin.

The defined skin wave has an extension that, in the case of a hair removal device having a comb and given standard pressures used during shaving, corresponds to at least half the thickness, and at most twice the thickness, of the front region of the comb. In the case of shaving heads or the like, the defined skin wave has a length and/or height of approximately 0.3 mm to 2 mm, preferably 0.6 mm to 1.5 mm, particularly preferably 0.8 mm to 1.2 mm, and in particular 1 mm.

According to a first advantageous embodiment of the present invention, it is provided that the spacer is fashioned so as to be stationary relative to the front line of action. In this manner, the skin wave between the spacer and the front line of action can be defined particularly well. In addition, this makes it possible for the assembly of a stationary spacer to be particularly simple and particularly compact.

According to an alternative embodiment, the spacer is mounted via means for exciting oscillation, so that during operation of the hair removal device the spacer oscillates relative to the front line of action. In this way, the advantage can be achieved that the hair removal device glides over the skin better, and, in addition, sets the upper skin layers into vibration through the oscillation, so that the upper skin layers are more strongly compressed and the hairs protrude still further from the skin. The oscillation can take place linearly in various directions, in particular in the plane of the skin or perpendicular thereto, or elliptically.

With regard to the positioning of the spacer, a distance of 0.7 mm to 1.5 mm of the spacer, and in particular 0.8 mm to 1.3 mm, relative to the front line of action, in the direction of a plane of use, has proven effective. Particularly preferably, the distance of the spacer from the front line of action is between 0.9 mm and 1.1 mm; in particular, it is preferably 1 mm.

The plane of use is determined by a plane tangential to the shaving or cutting device through the line of action, i.e., for example, through an upper side of a beard trimmer or an upper side of a shaving foil. Given the presence of guide devices, situated relative to the shaving or cutting device for example in the form of guide plates, the plane of use is determined by a guide plane that is determined by the guide device. The plane of use is an imaginary plane that coincides with a local skin plane in the area of the line of action.

The distance in the direction of the plane of use is measured from the line of action to a zenith of an envelope of the spacer, relative to the plane of use.

In addition, it is preferable for the spacer to be set lower relative to the stated plane of use, perpendicular thereto, by a distance of 0.7 mm to 1.2 mm, preferably 0.9 mm to 1.1 mm, and particularly preferably 1.0 mm from the front line of action; i.e., further away from the skin than the front line of action of the shaving or cutting device. The spacer is preferably set back relative to the skin according to the advantageous embodiment.

With regard to the two above-named advantageous embodiments, it has been shown that given distances greater than those indicated, larger skin waves are produced that cause a greater skin expansion or skin deformation and that, in addition, produce insufficient curvatures in the skin wave, so that the hairs to be cut do not protrude far enough from the skin. Longer hairs that are nonetheless engaged then cannot be cut as short as would be optimally possible. In the case of smaller distances, no wave is produced, so that the advantages of the present invention cannot be achieved. Given a too-low or too-high arrangement of the spacer perpendicular to the plane of use, either no contact is achieved between the shaving system and the skin, or no contact is achieved between the spacer and the skin.

Particularly uniform shaving results can be achieved if the spacer is situated parallel to the front line of action. If the line of action is curved, it has proven to be advantageous if the spacer is also curved. Given essentially straight lines of action, the spacer is also preferably straight. With the aid of such parallel spacers, a particularly uniform shaving result can be achieved over the entire width.

Preferably, the spacer has a cross-sectional expansion between 0.5 and 1.2 mm, preferably 0.7 mm to 0.9 mm, and particularly preferably 0.8 mm. Spacers having such cross-sectional extensions result in a particularly comfortable sliding of the spacer over the skin. Given such cross-sectional extensions, the skin is not compressed too strongly, and the spacer cannot cut into the skin. In particular, if the spacer were made thinner, such unpleasant cutting sensations could occur, and the skin could be more strongly irritated. Given thicker cross-sections, the skin is too strongly compressed in the area in front of the spacer, so that again too-large advance tensions would occur in the skin, causing skin irritations.

The distance perpendicular to the direction of the plane of use is measured from the line of action to a zenith of the spacer, relative to the plane of use, i.e., when viewed perpendicular to the plane of use, it is the smallest open space between the spacer and the line of action. Particularly preferably, the spacer has a round cross-section. Such a round cross-section can prevent skin irritations in a particularly effective manner. In addition, spacers having a round cross-section glide over the skin particularly well.

In addition, it is preferable for the spacer to be fashioned as a wire or as a wire clip. Such a configuration can be realized in a particularly economical manner.

In addition, the spacer may be fashioned as a roller, a brush, or a comb, whereby additional useful functions can be integrated into the spacer, such as a massage of the skin that promotes blood circulation.

In addition, the spacer can preferably have a means for dispensing substances onto the skin, such as lotions, creams, or the like, which can have a positive influence on the shaving result and can contribute to skin soothing and disinfection.

In addition, it is particularly preferable if an area around the spacer is kept free. This area is preferably at least a three-quarter ellipse having a major semiaxis between 0.5 mm and 2 mm, or preferably 1.5 mm, and a minor semiaxis between 0.25 and 1.5 mm, or preferably 0.75 mm. Preferably, the major semiaxis is oriented in the direction of the plane of use. In this manner, another skin wave having the size of the open area can be fashioned in front of the spacer, serving to pre-tension the skin.

If, in addition, the shaving or cutting device is held on the hair removal device in an adjustable fashion, the versatility of the hair removal device can be increased, in particular if this shaving or cutting device is fashioned as a front or center blade of a shaving head razor.

Particularly preferably, the hair removal device is fashioned as a cutting device. Such cutting devices generally have front lines of action that can be defined very well, so that the device can be very successfully used.

If, alternatively, the shaving or cutting device is fashioned as a shaving device, the design according to the present invention can be applied particularly fruitfully, because corresponding shaving devices are mostly used in dry or electric shavers, as well as in pre-cutters that operate according to the clipper principle.

Another outstanding embodiment of the hair removal device is its design as a center cutter, beard pre-cutter, or beard trimmer. Center cutters are cutting devices that are situated between two shaving heads.

In addition, a plurality of spacers may advantageously be provided on a device; for example, in a shaving head razor they may be provided on either side of the zenith, and in a double shaving head system they may be provided on the left and on the right shaving head, or two spacers each may be provided on the left and on the right shaving head, or, in shaving head razors having beard trimmers, they may be provided both on the shaving head or heads and on the beard trimmer. Correspondingly, the same holds true for rotary shaving systems.

### BRIEF DESCRIPTION OF THE DRAWINGS

Further goals, advantages, features, and possible uses of the present invention result from the following description of an exemplary embodiment on the basis of the drawing. In this case, all described and/or graphically represented features represent, alone or in arbitrary rational combination, the subject matter of the present invention, independent of their summarization in the claims or their references.

FIG. 1 shows a segment of a hair cutting system according to the present invention;

FIG. 2 shows the hair cutting system according to the present invention from FIG. 1 during use;

FIG. 3 shows a hair cutting system according to the prior art;

FIG. 4 shows an alternative embodiment of a hair cutting system according to the present invention, and

FIGS. 5 and 6 show various embodiments of a hair cutting system according to the present invention.

### DETAILED DESCRIPTION OF THE INVENTION

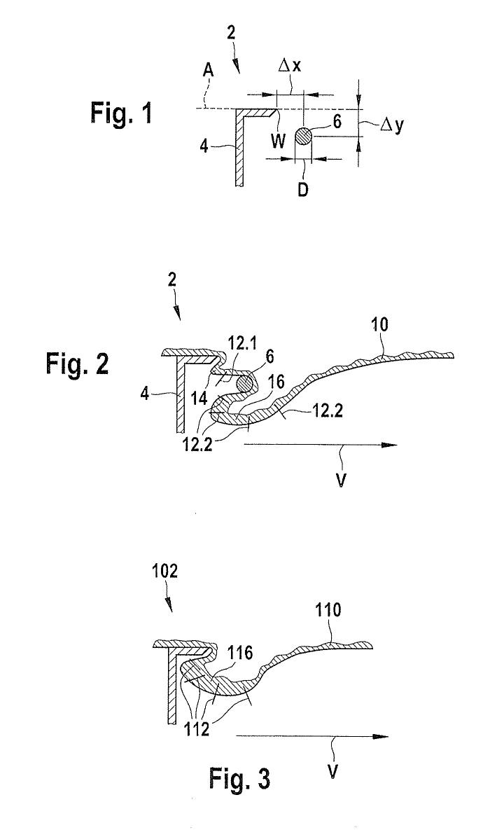

FIG. 1 shows a haircutting system 2 according to the present invention, having a shaving and cutting device 4 that has a front line of action W.

At a distance from front line of action W, there is provided a spacer 6 that is positioned in front of a plane of use A by Δx=1 mm and is set lower relative thereto by Δy=1 mm. Δx is relative to a midpoint of spacer 6. The distance Δy perpendicular to the plane of use is measured from the line of action to a zenith of the spacer, relative to the plane of use.

The spacer has a round cross-section having a diameter of 0.8 mm.

FIG. 2 shows hair removal device 2 according to the present invention, during use on a skin surface 10 of a user in order to remove beard hairs 12.1, 12.2.

Spacer 6 creates two skin waves 14, 16 in the skin 10, skin wave 14 being produced between spacer 6 and shaving or cutting device 4, and second skin wave 16 being produced in a direction of motion V in front of spacer 6. First skin wave 14 has a radius of approximately 1 mm, which results in the lifting of beard hair 12.1, and not to its sinking into skin 10. Further beard hairs 12.2, which are situated on second skin wave 16, are, in contrast, situated deeper in skin 10.

When hair removal device 2 is advanced in advance direction V, hair removal device 2 glides over skin 10, without the bulge of a large skin wave (FIG. 3) due to spacer 6, and thus causes particularly minor irritation of skin 10 due to the hair removal, because the advance tension exerted on skin 10 is significantly less than would be the case without spacer 6, or with a spacer having significantly larger dimensions.

FIG. 3 shows a hair removal device 102 without a spacer, known from the prior art. This has the result that a significantly larger skin wave 116 is formed on skin 110, with the result that beard hairs 112 withdraw below the surface of the skin 110. In addition, due to the large skin wave 116, a large advance tension is exerted on the skin, which results in overextensions of the skin and can thus cause small cracks in the skin that are perceived as skin irritation.

FIG. 4 shows an alternative embodiment of a hair removal device 22 having a shaving and cutting device 24 that is fashioned in the manner of shaving and cutting device 4 in FIG. 1.

A spacer 26 is dimensioned and positioned in a manner similar to spacer 6, but is suspended relative to shaving and cutting device 24 so as to oscillate in the direction of a plane of use A.

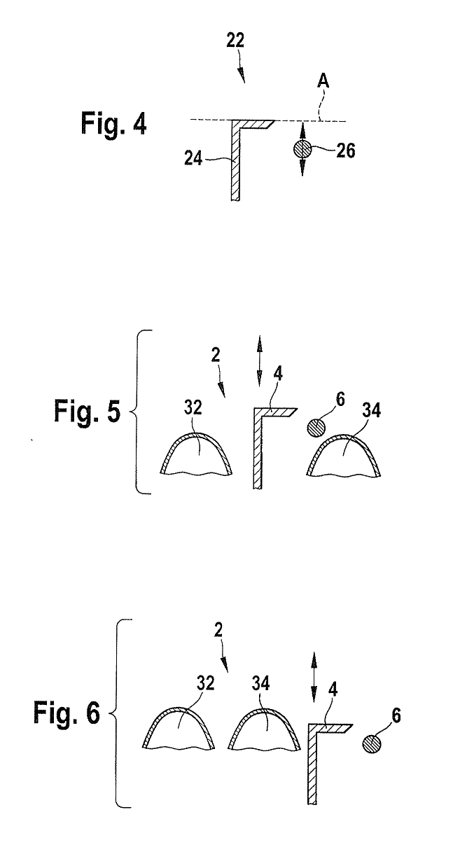

FIGS. 5 and 6 show various possible arrangements of spacer 6 and of shaving and cutting device 4 relative to a double shaving head having a first shaving head 32 and a second shaving head 34.

According to FIG. 5, the system according to the present invention is fashioned as a center hair trimmer, whereas in FIG. 6 it is fashioned as a front-positioned trimmer.

Spacer 6 can be fastened to shaving or cutting device 4, so that displaceability, or extensibility and retractability, of shaving and cutting device 4 can be realized in a particularly simple manner.

With the aid of spacer 6, a much more flexible use is possible of a pre-cutter for longer hairs, and a positioning thereof in front of shaving head 32 is enabled as in FIG. 6, because spacer 6 enables flexible positioning of the pre-cutter, because spacer 6 prevents the pre-cutter from cutting into the skin of the user.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

What is claimed is:

1. A hair removal device having a shaving or cutting device for the removal of hairs, the shaving or cutting device having a front line of action along which hairs are removed by the shaving or cutting device, wherein, in front of the shaving or cutting device, there is situated a spacer for producing a defined skin wave between the front line of action and the spacer, the spacer being situated at a distance from the front line of action.

2. The hair removal device as recited in claim 1, wherein the spacer is held stationary relative to the front line of action.

3. The hair removal device as recited in claim 1, wherein the spacer is mounted via means for exciting oscillation.

4. The hair removal device as recited in claim 1, wherein, relative to a plane of use of the hair removal device, the spacer has a distance of about 0.5 mm to 2 mm from the front line of action, in the direction of a plane of use.

5. The hair removal device as recited in claim 1, wherein, relative to a plane of use of the hair removal device, the spacer has a distance of 0.7 mm to 1.5 mm from the front line of action, in the direction of a plane of use.

6. The hair removal device as recited in claim 1, wherein, relative to a plane of use of the hair removal device, the spacer has a distance of 0.9 mm to 1.1 mm from the front line of action, perpendicular to a plane of use.

7. The hair removal device as recited in claim 1, wherein the spacer is situated parallel to the front line of action.

8. The hair removal device as recited in claim 1, wherein the spacer has a cross-sectional extension of between about 0.5 and 1.2 mm.

9. The hair removal device as recited in claim 1, wherein the spacer has a cross-sectional extension of between about 0.7 mm to 0.9 mm.

10. The hair removal device as recited in claim 1, wherein the spacer has a round cross-section.

11. The hair removal device as recited in claim 1, wherein the spacer is fashioned as a wire or as a wire clip.

12. The hair removal device as recited in claim 1, wherein the spacer is fashioned as a roller, brush, or comb.

13. The hair removal device as recited in claim 1, wherein the spacer has means for dispensing substances onto the skin.

14. The hair removal device as recited in claim 1, wherein a region around the spacer is open, the region being at least a three-quarter ellipse having a major semiaxis of between 0.5 mm and 2 mm, and a minor semiaxis of between 0.25 and 1.5 mm.

15. The hair removal device as recited in claim 14, wherein a region around the spacer is open, the region being at least a three-quarter ellipse having a major semiaxis of about 1.5 mm.

16. The hair removal device as recited in claim 14, wherein a region around the spacer is open, the region being at least a three-quarter ellipse having a minor semiaxis of about 0.75 mm.

17. The hair removal device as recited in claim 1, wherein the shaving or cutting device is held on the hair removal device so as to be adjustable.

18. The hair removal device as recited in claim 1, wherein the shaving or cutting device is a cutting device.

19. The hair removal device as recited in claim 1, wherein the shaving or cutting device is a shaving device.

20. The hair removal device as recited in claim 1, wherein the shaving or cutting device is a center cutter, a beard pre-cutter, or a beard trimmer.
